(19) United States
(12) Patent Application Publication
(10) Pub. No.: US 2026/0214733 A1
(43) Pub. Date: Jul. 23, 2026

(54) APPARATUS, SYSTEM, AND METHOD OF NON-COLLOCATED MULTI-LINK-DEVICE (MLD) INDICATION

(71) Applicant: INTEL CORPORATION, Santa Clara, CA (US)

(72) Inventors: Laurent Cariou, Milizac (FR); Daniel Bravo, Portland, OR (US); Po-Kai Huang, San Jose, CA (US)

(73) Assignee: INTEL CORPORATION, Santa Clara, CA (US)

(21) Appl. No.: 19/133,489

(22) PCT Filed: Dec. 29, 2022
(86) PCT No.: PCT/US2022/054256

§ 371 Date: May 28, 2025

(51) Int. Cl. H04W 76/15; H04W 48/16

(52) U.S. Cl. CPC H04W 76/15; H04W 48/16

(57) ABSTRACT

For example, an Access Point (AP) may be configured to set Multi-Link Device (MLD) information to indicate that the AP is affiliated with a non-collocated AP MLD. For example, the non-collocated AP MLD may include at least one other AP which is not collocated with the AP in a same physical device. For example, the AP may be configured to transmit a frame including the MLD information. For example, a non-AP wireless communication station (STA) may be configured to receive the MLD information from the AP, and to determine, based on the MLD information, that the AP is affiliated with the non-collocated AP MLD. For example, the STA may be configured to transmit a Multi-Link (ML) probe request to the AP. For example, the ML probe request may be configured to request information corresponding to the non-collocated AP MLD.

### TECHNICAL FIELD

Aspects described herein generally relate to non-collocated Multi-Link-Device (MLD) indication.

### BACKGROUND

Some wireless communication networks may provide high-throughput data for users of wireless communication devices.

For example, devices in a wireless communication system may be configured to communicate according to communication protocols, which may be configured to support high-throughput data for users of wireless communication devices.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic illustration of a non-collocated Access Point (AP) Multi-Link-Device (MLD), in accordance with some demonstrative aspects.

FIG. 5 is a schematic flow-chart illustration of a method of non-collocated MLD indication, in accordance with some demonstrative aspects.

FIG. 6 is a schematic flow-chart illustration of a method of non-collocated MLD indication, in accordance with some demonstrative aspects.

FIG. 7 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); and/or IEEE 802.11be (IEEE P802.11be/D2.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), May 2022)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by a mmWave STA (mSTA), which may include for example, a STA having a radio transmitter, which is capable of operating on a channel that is within the mmWave frequency band. In one example, mm Wave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

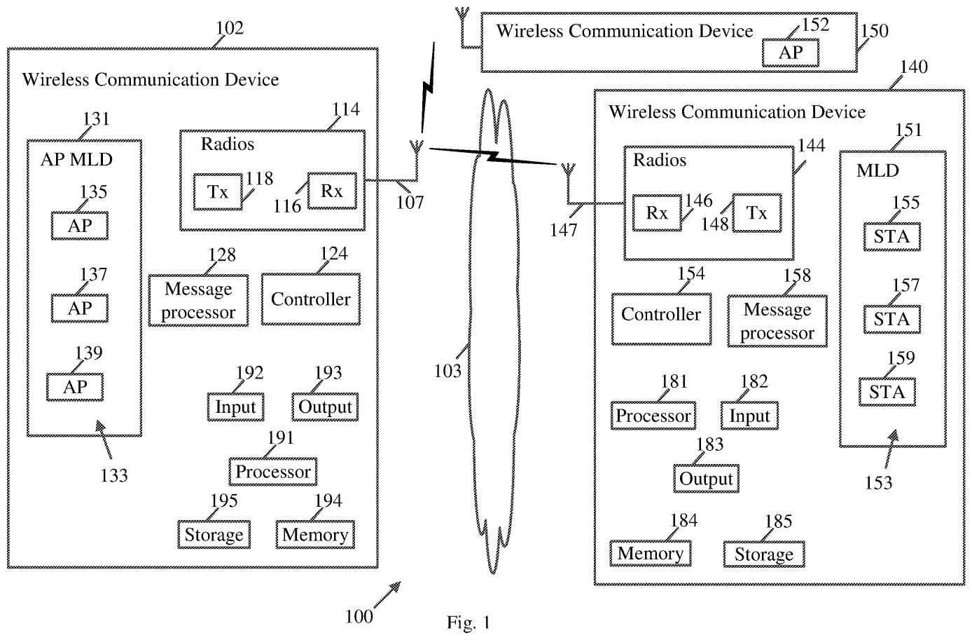

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 150, and/or one or more other devices.

In some demonstrative aspects, devices 102, 140 and/or 150 may include a mobile device or a non-mobile, e.g., a static, device.

For example, devices 102, 140 and/or 150 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a floppy disk drive, a Compact Disk (CD) drive, a CD-ROM drive, a DVD drive, or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 150 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternative include one or more channels in an mmWave wireless communication frequency band.

In other aspects, WM 103 may include any other type of channel over any other frequency band.

In some demonstrative aspects, device 102, device 140, and/or device 150 may include one or more radios including circuitry and/or logic to perform wireless communication between devices 102, 140, 150 and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more, e.g., a plurality of, antennas.

In some demonstrative aspects, device 102 may include one or more antennas 107, e.g., a single antenna 107 or a plurality of antennas 107, and/or device 140 may include one or more antennas 147, e.g., a single antenna 147 or a plurality of antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 150 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 150 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 150 may include, operate as, perform the role of, and/or perform one or more functionalities of, one or more STAs. For example, device 102 may include at least one STA, device 140 may include at least one STA, and/or device 150 may include at least one STA.

In some demonstrative aspects, device 102, device 140, and/or device 150 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, devices 102, 140 and/or 150 may be configured to perform one or more operations, and/or functionalities of a WiFi 8 STA.

In other aspects, for example, devices 102, 140 and/or 150 may be configured to perform one or more operations, and/or functionalities of an Ultra High Reliability (UHR) STA.

In other aspects, for example, devices 102, 140 and/or 150 may be configured to perform one or more operations, and/or functionalities of any other additional or alternative type of STA.

In other aspects, device 102, device 140, and/or device 150 may include, operate as, perform the role of, and/or perform one or more functionalities of, any other wireless device and/or station, e.g., a WLAN STA, a WiFi STA, and the like.

In some demonstrative aspects, device 102, device 140, and/or device 150 may be configured operate as, perform the role of, and/or perform one or more functionalities of, an Access Point (AP), e.g., an EHT AP STA.

In some demonstrative aspects, device 102, device 140, and/or device 150 may be configured to operate as, perform the role of, and/or perform one or more functionalities of, a non-AP STA, e.g., an EHT non-AP STA.

In other aspects, device 102, device 140, and/or device 150 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 150 may be configured to communicate in an EHT network, and/or any other network.

In some demonstrative aspects, devices 102, 140, and/or 150 may be configured to operate in accordance with one or more Specifications, for example, including one or more IEEE 802.11 Specifications, e.g., an IEEE 802.11-2020 Specification, an IEEE 802.11be Specification, and/or any other specification and/or protocol.

In some demonstrative aspects, device 102, device 140, and/or device 150 may include, operate as, perform a role of, and/or perform the functionality of, one or more multi-link logical entities, e.g., as described below.

In other aspect, device 102, device 140, and/or device 150 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102, device 140, and/or device 150 may include, operate as, perform a role of, and/or perform the functionality of, a Multi-Link Device (MLD). For example, device 102 may include, operate as, perform a role of, and/or perform the functionality of, at least one MLD, device 150 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity and has more than one affiliated STA and has a single MAC service access point (SAP) to LLC, which includes one MAC data service. In one example, the MLD may include a logical entity that is capable of supporting more than one affiliated STA, but can also operate using one or more affiliated STAs, and has one MAC data service and a single MAC SAP to the LLC sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 150 may be configured to operate as, perform the role of, and/or perform one or more functionalities of, an AP MLD.

In some demonstrative aspects, device 102, device 140, and/or device 150 may be configured to operate as, perform the role of, and/or perform one or more functionalities of, a non-AP MLD.

In other aspects, device 102, device 140, and/or device 150 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to cause, trigger, instruct and/or control device 102 to operate as, perform a role of, and/or perform one or more operations and/or functionalities of, an AP MLD 131 including a plurality of AP STAs 133, e.g., including an AP STA 135, an AP STA 137 and/or an AP STA 139. In some aspects, as shown in FIG. 1, AP MLD 131 may include three AP STAs. In other aspects, AP MLD 131 may include any other number of AP STAs.

In one example, AP STA 135, AP STA 137 and/or AP STA 139 may operate as, perform a role of, and/or perform one or more operations and/or functionalities of, an EHT AP STA. In other aspects, AP STA 135, AP STA 137 and/or AP STA 139 may perform any other additional or alternative functionality.

In some demonstrative aspects, for example, the one or more radios 114 may include, for example, a radio for communication by AP STA 135 over a first wireless communication frequency channel and/or frequency band, e.g., a 2.4 GHz band, as described below.

In some demonstrative aspects, for example, the one or more radios 114 may include, for example, a radio for communication by AP STA 137 over a second wireless communication frequency channel and/or frequency band, e.g., a 5 GHz band, as described below.

In some demonstrative aspects, for example, the one or more radios 114 may include, for example, a radio for communication by AP STA 139 over a third wireless communication frequency channel and/or frequency band, e.g., a 6 GHz band, as described below.

In some demonstrative aspects, the radios 114 utilized by APs 133 may be implemented as separate radios. In other aspects, the radios 114 utilized by APs 133 may be implemented by one or more shared and/or common radios and/or radio components.

In other aspects, controller 124 may be configured to cause, trigger, instruct and/or control device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to cause, trigger, instruct and/or control device 140 to operate as, perform a role of, and/or perform one or more operations and/or functionalities of, an MLD 151 including a plurality of STAs 153, e.g., including a STA 155, a STA 157 and/or a STA 159. In some aspects, as shown in FIG. 1, MLD 151 may include three STAs. In other aspects, MLD 151 may include any other number of STAs.

In one example, STA 155, STA 157 and/or STA 159 may operate as, perform a role of, and/or perform one or more operations and/or functionalities of, an EHT STA. In other aspects, STA 155, STA 157 and/or STA 159 may perform any other additional or alternative functionality.

In some demonstrative aspects, for example, the one or more radios 144 may include, for example, a radio for communication by STA 155 over a first wireless communication frequency channel and/or frequency band, e.g., a 2.4 GHz band, as described below.

In some demonstrative aspects, for example, the one or more radios 144 may include, for example, a radio for communication by STA 157 over a second wireless communication frequency channel and/or frequency band, e.g., a 5 GHz band, as described below.

In some demonstrative aspects, for example, the one or more radios 144 may include, for example, a radio for communication by STA 159 over a third wireless communication frequency channel and/or frequency band, e.g., a 6 GHz band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to cause, trigger, instruct and/or control MLD 151 to operate as, perform a role of, and/or perform one or more operations and/or functionalities of, a non-AP MLD. For example, STA 155, STA 157 and/or STA 159 may operate as, perform a role of, and/or perform one or more operations and/or functionalities of, a non-AP EHT STA.

In some demonstrative aspects, controller 154 may be configured to cause, trigger, instruct and/or control MLD 151 to operate as, perform a role of, and/or perform one or more operations and/or functionalities of, an AP MLD. For example, STA 155, STA 157 and/or STA 159 may operate as, perform a role of, and/or perform one or more operations and/or functionalities of, an AP EHT STA.

In other aspects controller 154 may be configured to cause, trigger, instruct and/or control device 140 to operate as, perform a role of, and/or perform one or more operations and/or functionalities of, any other additional or alternative entity and/or STA, e.g., a single STA, multiple STAs, and/or a non-MLD entity.

In some demonstrative aspects, device 150 may be configured to operate as, perform a role of, and/or perform one or more operations and/or functionalities of, one or more APs, e.g., including an AP STA 152.

In some demonstrative aspects, device 150 may be configured to operate as, perform a role of, and/or perform one or more operations and/or functionalities of, an AP MLD including AP STA 152.

In one example, AP STA 152 may operate as, perform a role of, and/or perform one or more operations and/or functionalities of, an EHT AP STA. In other aspects, AP STA 152 may perform any other additional or alternative functionality.

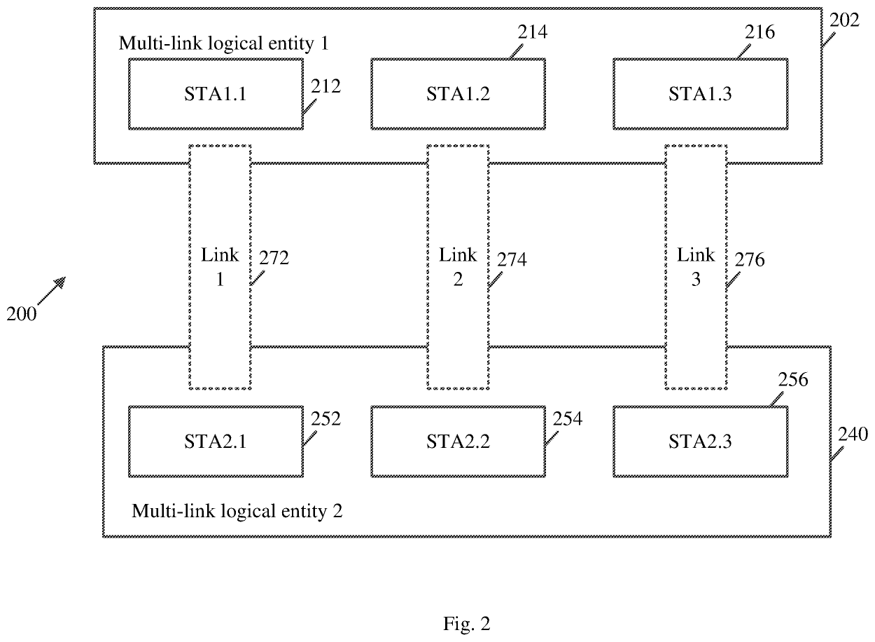

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, and a STA 216. In one example, AP MLD 131 (FIG. 1) may perform one or more operations, one or more functionalities, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, and a STA 256. In one example, MLD 151 (FIG. 1) may perform one or more operations, one or more functionalities, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, and/or a link 276 between STA 216 and STA 256.

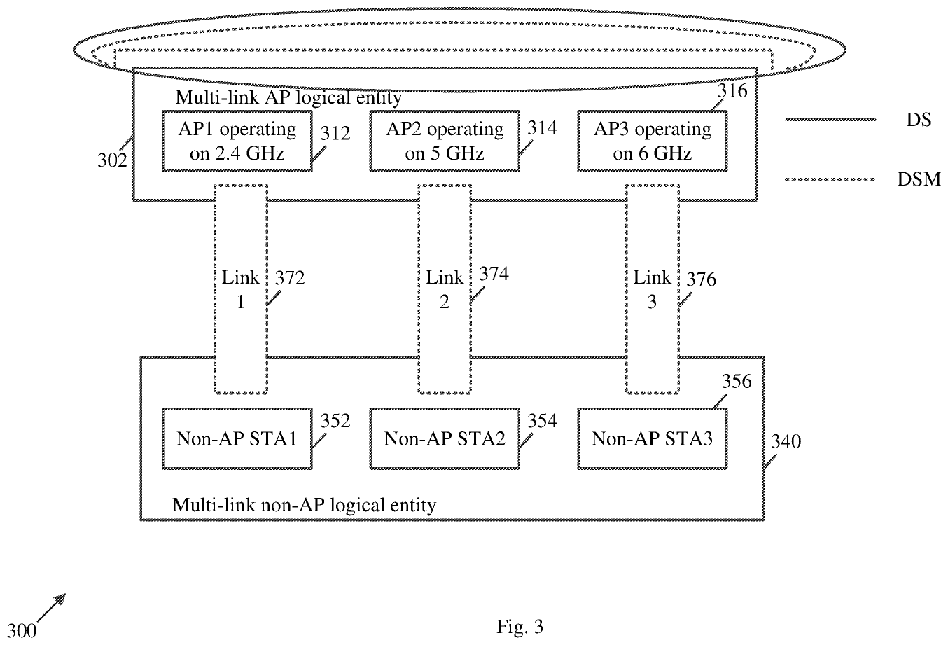

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAs, e.g., including an AP STA 312, an AP STA 314, and an AP STA 316. In one example, AP MLD 131 (FIG. 1) may perform one or more operations, one or more functionalities, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, and a non-AP STA 356. In one example, MLD 151 (FIG. 1) may perform one or more operations, one or more functionalities, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, and/or a link 376 between AP STA 316 and non-AP STA 356.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 GHz frequency band, AP STA 314 may be configured to communicate over a 5 GHz frequency band, and/or AP STA 316 may be configured to communicate over a 6 GHz frequency band. In other aspects, AP STA 312, AP STA 314, and/or AP STA 316, may be configured to communicate over any other additional or alternative wireless communication frequency bands.

Referring back to FIG. 1, in some demonstrative aspects, devices 102, 140 and/or 150 may be configured to perform wireless communication according to a non-collocated MLD operation mechanism, e.g., as described below.

In some demonstrative aspects, the non-collocated MLD operation mechanism may be configured to provide a technical solution to support smooth mobility, e.g., mobility with zero or low latency and/or with zero or low packet loss transitions between APs in different locations, e.g., as described below.

For example, the non-collocated MLD operation mechanism may be configured to provide a technical solution to support affiliation of non-collocated APs with the same AP MLD.

For example, the non-collocated MLD operation mechanism may be configured to provide a technical solution to support affiliation of non-collocated non-AP STAs with the same non-AP MLD.

In some demonstrative aspects, a collocated AP MLD may include a collocated AP set including a plurality of collocated APs.

In some demonstrative aspects, the collocated AP MLD may include an AP MLD, which includes a set of two or more APs that are co-located in the same physical device.

In some demonstrative aspects, a non-collocated AP MLD (also referred to as “multi-AP MLD”) may include an AP MLD, which includes a set of two or more APs, of which at least two APs are not co-located in the same physical device.

In some demonstrative aspects, the non-collocated AP MLD may include a non-collocated AP set including two or more non-collocated APs.

In some demonstrative aspects, the non-collocated AP MLD may include one or more collocated AP MLDs.

In some demonstrative aspects, the non-collocated AP MLD may be configured to have one MAC data service and a single MAC SAP to an LLC layer.

In some demonstrative aspects, the non-collocated MLD may be defined as an MLD that may have multiple non-collocated affiliated APs.

In some demonstrative aspects, the non-collocated MLD may be defined according to an MLD definition allowing all APs in an ESS to be affiliated to the same AP MLD.

In some demonstrative aspects, it may be defined that the same security keys may be used on all APs affiliated to the same AP MLD, for example, even if the APs are not collocated.

In other aspects, different security keys may be used by APs of an MLD. For example, the same keys may be used within a group of collocated APs, while different keys may be used between different groups of APs.

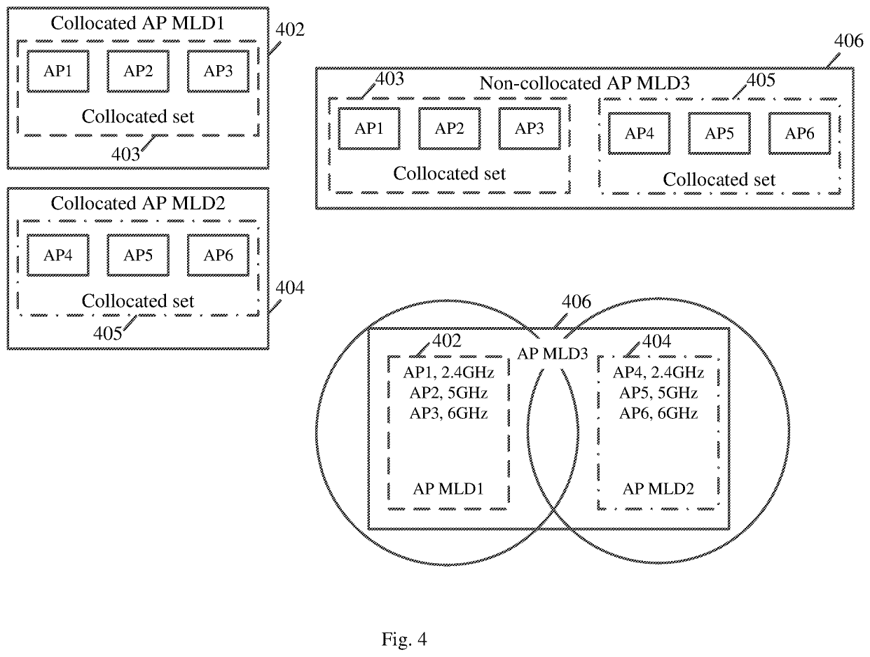

Reference is made to FIG. 4, which schematically illustrates a non-collocated AP MLD 406, which may be implemented in accordance with some demonstrative aspects.

In some demonstrative aspects, as shown in FIG. 4, the non-collocated AP MLD 406 may include a plurality of collocated AP MLDs, for example, including a collocated AP MLD 402, and a collocated AP MLD 404.

In one example, collocated AP MLD 402 may include AP MLD 131 (FIG. 1). In one example, collocated AP MLD 404 may include an AP MLD of device 150 (FIG. 1).

In some demonstrative aspects, as shown in FIG. 4, collocated AP MLD 402 may include a plurality of APs, e.g., including a first AP, denoted AP1, a second AP, denoted AP2, and/or a third AP, denoted AP3, which are collocated in the same physical device, e.g., a first physical device.

In some demonstrative aspects, as shown in FIG. 4, collocated AP MLD 404 may include a plurality of APs, e.g., including a first AP, denoted AP4, a second AP, denoted AP5, and/or a third AP, denoted AP6, which are collocated in the same physical device, e.g., a second physical device separate from the first physical device.

In some demonstrative aspects, as shown in FIG. 4, non-collocated AP MLD 406 may include APs of collocated AP MLD 402 and APs of collocated AP MLD 404. For example, non-collocated AP MLD 406 may include a collocated set 403, e.g., including AP1, AP2, and AP3, and/or a collocated set 405, e.g., including AP4, AP5, and AP6.

In some demonstrative aspects, it may be defined that a set, e.g., every set, of collocated APs may have a dedicated AP MLD. For example, as shown in FIG. 4, collocated AP MLD 402 may include a set of collocated APs, e.g., including AP1, AP2, and/or AP3; and/or collocated AP MLD 404 may include a set of collocated APs, e.g., including AP4, AP5, and/or AP6.

In some demonstrative aspects, a non-collocated AP MLD, e.g., non-collocated AP MLD 406, may be defined as a new type of an AP MLD configured to overlap with one or more existing, e.g., collocated, AP MLDs, e.g., AP MLD 402 and AP MLD 404.

In some demonstrative aspects, non-AP MLDs which support a non-collocated MLD operation, e.g., UHR non-AP MLDs, may be able to associate with the non-collocated AP MLD, e.g., non-collocated AP MLD 406.

In some demonstrative aspects, non-AP MLDs which do not support the non-collocated MLD operation, e.g., EHT non-AP MLDs which are non-UHR non-AP MLDs, may be able to associate with collocated AP MLDs, e.g., collocated AP MLD 402 and/or collocated AP MLD 404.

In some demonstrative aspects, STAs which do not support the non-collocated MLD operation, e.g., non-UHR STAs, may not be able to understand if the two AP MLDs have the same AP MLD MAC address.

In some demonstrative aspects, the STAs which do not support the non-collocated MLD operation, e.g., non-UHR STAs, may transition between APs of AP MLD 402 and AP MLD 404, for example, using a Fast session Transfer (FT) protocol.

In some demonstrative aspects, the non-collocated MLD operation may be configured to support backward compatibility, for example, in presence of one or more STAs, e.g., STAs accordance with the 802.11be Specification, which may not support the non-collocated MLD operation.

For example, the non-collocated MLD operation may be implemented by UHR STAs. According to this example, the non-collocated MLD operation may be configured to support backward compatibility, for example, in presence of non-UHR STAs.

Referring back to FIG. 1, in some demonstrative aspects, devices 102, 140 and/or 150 may be configured to implement a non-collocated MLD operation mechanism, which may be configured to utilize MLD information to discover/advertise a non-collocated MLD, e.g., as described below.

In some demonstrative aspects, controller 124 may be configured to control, trigger, cause, and/or instruct an AP implemented by device 102 to set MLD information to indicate that the AP is affiliated with a non-collocated AP MLD, e.g., as described below.

In some demonstrative aspects, the non-collocated AP MLD may include at least one other AP which is not collocated with the AP in a same physical device 102, e.g., as described below.

In some demonstrative aspects, the non-collocated AP MLD may have one MAC data service and a single MAC SAP to an LLC layer.

In some demonstrative aspects, the non-collocated AP MLD may include one or more collocated AP MLDs, e.g., as described below.

In some demonstrative aspects, a collocated AP MLD may include a collocated AP set including a plurality of collocated APs, e.g., as described above.

In some demonstrative aspects, controller 124 may be configured to control, trigger, cause, and/or instruct the AP implemented by device 102 to transmit a frame including the MLD information, e.g., as described below.

In some demonstrative aspects, the frame may include a beacon frame.

In some demonstrative aspects, the frame may include a probe response frame.

In other aspects, the frame may include any other type of frame.

In some demonstrative aspects, the MLD information in the frame may be configured to indicate that the AP is affiliated with both the non-collocated AP MLD and the collocated AP MLD, e.g., as described below.

For example, the MLD information transmitted by the AP implemented by device 102 may indicate that the AP is part of collocated AP MLD 131 and a non-collocated AP MLD, e.g., including collocated AP MLD 131 and an AP, which is not part of device 102, e.g., AP 152.

In some demonstrative aspects, controller 124 may be configured to control, trigger, cause, and/or instruct the AP implemented by device 102 to set the MLD information in an MLD parameters field of the frame, e.g., as described below.

In some demonstrative aspects, the frame may include a Reduced Neighbor Report (RNR) element, e.g., as described below.

In some demonstrative aspects, the RNR element may include a neighbor AP information field including a Target Beacon Transmission Time (TBTT) information field, e.g., as described below.

In some demonstrative aspects, the TBTT information field may include the MLD parameters field, e.g., as described below.

In some demonstrative aspects, controller 124 may be configured to control, trigger, cause, and/or instruct the AP implemented by device 102 to set a non-collocated AP MLD indication in the MLD parameters field of the frame, for example, to indicate that the AP is affiliated with the non-collocated AP MLD, e.g., as described below.

In some demonstrative aspects, controller 124 may be configured to control, trigger, cause, and/or instruct the AP implemented by device 102 to set an MLD Identifier (ID) and a non-collocated AP MLD flag in the MLD parameters field of the frame, e.g., as described below.

In some demonstrative aspects, the non-collocated AP MLD flag in the MLD parameters field may be configured to indicate that the non-collocated AP MLD is to be identified, for example, based on a combination of the MLD ID and the non-collocated AP MLD flag, e.g., as described below.

In some demonstrative aspects, controller 124 may be configured to control, trigger, cause, and/or instruct the AP implemented by device 102 to set in the MLD parameters field an MLD ID of a collocated AP MLD affiliated with the AP, e.g., as described below.

In some demonstrative aspects, controller 124 may be configured to control, trigger, cause, and/or instruct the AP implemented by device 102 to set the non-collocated AP MLD flag to a predefined value, for example, to indicate that the non-collocated AP MLD is to be identified by the MLD ID of the collocated AP MLD, e.g., as described below.

In some demonstrative aspects, controller 124 may be configured to control, trigger, cause, and/or instruct the AP implemented by device 102 to set the non-collocated AP MLD flag to a flag value, for example, to indicate that the non-collocated AP MLD is to be identified by a non-collocated AP MLD ID, e.g., as described below.

In some demonstrative aspects, the non-collocated AP MLD ID may be based, for example, on a sum of the MLD ID of the collocated AP MLD and a gap value, e.g., as described below.

In some demonstrative aspects, is the gap value may be based, for example, on the flag value, e.g., as described below.

In other aspects, the non-collocated AP MLD ID may be determined based on any other calculation and/or definition applied to the MLD ID of the collocated AP MLD and the flag value.

In some demonstrative aspects, controller 124 may be configured to control, trigger, cause, and/or instruct the AP implemented by device 102 to set a first MLD parameters field and a second MLD parameter field in the frame, e.g., as described below.

In some demonstrative aspects, the first MLD parameters field may be configured to include a first MLD ID to identify the collocated AP MLD affiliated with the AP, e.g., as described below.

In some demonstrative aspects, the second MLD parameters field may be configured to include a second MLD ID to identify the non-collocated AP MLD, e.g., as described below.

For example, the first MLD parameters field may include a first MLD ID to identify AP MLD 131, and the second MLD parameters field may include second MLD ID to identify the non-collocated MLD with which the AP MLD 131 is affiliated.

In some demonstrative aspects, controller 124 may be configured to control, trigger, cause, and/or instruct the AP implemented by device 102 to set a non-collocated AP MLD indication in a Multi-Link Element (MLE) of the frame, for example, to indicate that the AP is affiliated with the non-collocated AP MLD, e.g., as described below.

In some demonstrative aspects, controller 124 may be configured to control, trigger, cause, and/or instruct the AP implemented by device 102 to set in the MLE an MLD ID of the non-collocated AP MLD.

In some demonstrative aspects, controller 124 may be configured to control, trigger, cause, and/or instruct the AP implemented by device 102 to set in the MLE an AP MLD MAC address of the non-collocated AP MLD, e.g., as described below.

In other aspects, controller 124 may be configured to control, trigger, cause, and/or instruct the AP implemented by device 102 to set in the MLE any other additional or alternative information corresponding to the non-collocated AP MLD.

In some demonstrative aspects, controller 124 may be configured to control, trigger, cause, and/or instruct the AP implemented by device 102 to set a non-collocated AP MLD information field in a common information field of the MLE, e.g., as described below.

In some demonstrative aspects, the non-collocated AP MLD information field in the common information field of the MLE may include the MLD ID of the non-collocated AP MLD, the AP MLD MAC address of the non-collocated AP MLD, and/or any other additional or alternative information corresponding to the non-collocated AP MLD, e.g., as described below.

In some demonstrative aspects, the MLE may include information of the collocated AP MLD affiliated with the AP, e.g., as described below.

In some demonstrative aspects, controller 124 may be configured to control, trigger, cause, and/or instruct the AP implemented by device 102 to set a first MLE and a second MLE in the frame, e.g., as described below.

In some demonstrative aspects, the first MLE may include information of the collocated AP MLD affiliated with the AP, e.g., as described below.

In some demonstrative aspects, the second MLE may include information of the non-collocated AP MLD, e.g., as described below.

For example, the first MLE may include information of AP MLD 131, and the second MLE may include information of the non-collocated AP MLD with which the AP MLD 131 is affiliated.

In some demonstrative aspects, controller 124 may be configured to control, trigger, cause, and/or instruct the AP implemented by device 102 to set an RNR element in the frame to advertise all APs, which are affiliated with a same AP MLD and which are part of a same collocated AP set as the AP, e.g., as described below.

In some demonstrative aspects, controller 124 may be configured to control, trigger, cause, and/or instruct the AP implemented by device 102 to process a Multi-Link (ML) probe request from a non-AP STA, e.g., as described below.

In some demonstrative aspects, controller 124 may be configured to control, trigger, cause, and/or instruct the AP implemented by device 102 to identify that the non-collocated AP MLD is targeted by the ML probe request, for example, based on an MLD ID in the ML probe request, e.g., as described below.

In some demonstrative aspects, controller 124 may be configured to control, trigger, cause, and/or instruct the AP implemented by device 102 to transmit an ML probe response to the non-AP STA, e.g., as described below.

In some demonstrative aspects, the ML probe response may include information of one or more APs affiliated with the non-collocated AP MLD, e.g., as described below.

In some demonstrative aspects, controller 124 may be configured to control, trigger, cause, and/or instruct the AP implemented by device 102 to identify a reported AP to be reported in the ML probe response, for example, based on a link ID field in the ML probe request, e.g., as described below.

For example, the AP implemented by device 102 may identify that AP 152 is to be included as a reported AP to be reported in the ML probe response.

In some demonstrative aspects, controller 124 may be configured to control, trigger, cause, and/or instruct the AP implemented by device 102 to include in the ML probe response information corresponding to the reported AP, e.g., as described below.

In some demonstrative aspects, controller 124 may be configured to control, trigger, cause, and/or instruct the AP implemented by device 102 to set a field in the ML probe response, for example, to indicate whether or not the ML probe response includes information of all APs affiliated with the non-collocated AP MLD, e.g., as described below.

In some demonstrative aspects, controller 154 may be configured to control, trigger, cause, and/or instruct a non-AP STA implemented by device 140 to process MLD information in a frame from an AP, e.g., as described below.

In some demonstrative aspects, the frame from the AP may include a beacon frame.

In some demonstrative aspects, the frame from the AP may include a probe response frame.

In other aspects, the frame from the AP may include any other suitable type of frame.

In some demonstrative aspects, the MLD information may include the MLD information transmitted by the AP implemented by device 102.

In some demonstrative aspects, controller 154 may be configured to control, trigger, cause, and/or instruct the non-AP STA implemented by device 140 to determine, for example, based on the MLD information in the frame from the AP, that the AP is affiliated with a non-collocated AP MLD, e.g., as described below.

In some demonstrative aspects, the non-collocated AP MLD may include at least one other AP which is not collocated with the AP in a same physical device, e.g., as described below.

In some demonstrative aspects, the non-collocated AP MLD may include one or more collocated AP MLDs, e.g., as described below.

In some demonstrative aspects, a collocated AP MLD may include a collocated AP set including a plurality of collocated APs, e.g., as described below.

In some demonstrative aspects, controller 154 may be configured to control, trigger, cause, and/or instruct the non-AP STA implemented by device 140 to transmit an ML probe request to the AP, e.g., as described below.

In some demonstrative aspects, the ML probe request may be configured to request information corresponding to the non-collocated AP MLD, e.g., as described below.

In some demonstrative aspects, controller 154 may be configured to control, trigger, cause, and/or instruct the non-AP STA implemented by device 140 to identify, for example, based on the MLD information from the AP, that the AP is affiliated with both the non-collocated AP MLD and a collocated AP MLD, e.g., as described below.

In some demonstrative aspects, controller 154 may be configured to control, trigger, cause, and/or instruct the non-AP STA implemented by device 140 to determine that the AP is affiliated with the non-collocated AP MLD, for example, based on a non-collocated AP MLD indication in an MLD parameters field of the frame from the AP, e.g., as described below.

In some demonstrative aspects, controller 154 may be configured to control, trigger, cause, and/or instruct the non-AP STA implemented by device 140 to identify the MLD information in the MLD parameters field of the frame, e.g., as described below.

In some demonstrative aspects, the frame received from the AP may include an RNR element, e.g., as described below.

In some demonstrative aspects, controller 154 may be configured to control, trigger, cause, and/or instruct the non-AP STA implemented by device 140 to process the RNR element in the frame to identify all APs, which are affiliated with a same AP MLD and which are part of a same collocated AP set as the AP, e.g., as described below.

In some demonstrative aspects, the RNR element may include a neighbor AP information field including a TBTT information field, which includes the MLD parameters field, e.g., as described below.

In some demonstrative aspects, controller 154 may be configured to control, trigger, cause, and/or instruct the non-AP STA implemented by device 140 to process the MLD parameters field of the frame to determine that the non-collocated AP MLD is to be identified, for example, based on a combination of an MLD ID and a non-collocated AP MLD flag in the MLD parameters field, e.g., as described below.

In some demonstrative aspects, controller 154 may be configured to control, trigger, cause, and/or instruct the non-AP STA implemented by device 140 to identify that the MLD parameters field includes an MLD ID of a collocated AP MLD affiliated with the AP, e.g., as described below.

In some demonstrative aspects, controller 154 may be configured to control, trigger, cause, and/or instruct the non-AP STA implemented by device 140 to determine, for example, based on a determination that the non-collocated AP MLD flag has a predefined value, that the non-collocated AP MLD is to be identified by the MLD ID of the collocated AP MLD, e.g., as described below.

In some demonstrative aspects, controller 154 may be configured to control, trigger, cause, and/or instruct the non-AP STA implemented by device 140 to determine that the non-collocated AP MLD is to be identified by a non-collocated AP MLD ID, which may be based on a sum of the MLD ID of the collocated AP MLD and a gap value, e.g., as described below.

In some demonstrative aspects, the gap value may be based on a flag value of the non-collocated AP MLD flag, e.g., as described below.

In some demonstrative aspects, controller 154 may be configured to control, trigger, cause, and/or instruct the non-AP STA implemented by device 140 to process a first MLD parameters field and a second MLD parameter field in the frame, e.g., as described below.

In some demonstrative aspects, the first MLD parameters field may include a first MLD ID to identify the collocated AP MLD affiliated with the AP.

In some demonstrative aspects, the second MLD parameters field may include a second MLD ID to identify the non-collocated AP MLD.

For example, the first MLD parameters field may include an MLD ID to identify AP MLD 131, and the second MLD parameters field may include an MLD ID to identify the non-collocated AP MLD with which the AP MLD 131 is affiliated.

In some demonstrative aspects, controller 154 may be configured to control, trigger, cause, and/or instruct the non-AP STA implemented by device 140 to determine that the AP is affiliated with the non-collocated AP MLD, for example, based on a non-collocated AP MLD indication in an MLE of the frame, e.g., as described below.

In some demonstrative aspects, controller 154 may be configured to control, trigger, cause, and/or instruct the non-AP STA implemented by device 140 to process the MLE to identify an MLD ID of the non-collocated AP MLD, an AP MLD MAC address of the non-collocated AP MLD, and/or any other additional or alternative information corresponding to the non-collocated AP MLD, e.g., as described below.

In some demonstrative aspects, controller 154 may be configured to control, trigger, cause, and/or instruct the non-AP STA implemented by device 140 to process a non-collocated AP MLD information field in a common information field of the MLE, e.g., as described below.

In some demonstrative aspects, the non-collocated AP MLD information field may include an MLD ID of the non-collocated AP MLD, an AP MLD MAC address of the non-collocated AP MLD, and/or any other additional or alternative information corresponding to the non-collocated AP MLD, e.g., as described below.

In some demonstrative aspects, the MLE of the frame from the AP may include information of a collocated AP MLD affiliated with the AP, e.g., as described below.

In some demonstrative aspects, controller 154 may be configured to control, trigger, cause, and/or instruct the non-AP STA implemented by device 140 to process a first MLE and a second MLE in the frame, e.g., as described below.

In some demonstrative aspects, the first MLE may include information of a collocated AP MLD affiliated with the AP, e.g., as described below.

In some demonstrative aspects, the second MLE may include information of the non-collocated AP MLD, e.g., as described below.

For example, the first MLE may include information of AP MLD 131, and the second MLE may include information of the non-collocated AP MLD with which the AP MLD 131 is affiliated.

In some demonstrative aspects, controller 154 may be configured to control, trigger, cause, and/or instruct the non-AP STA implemented by device 140 to set an MLD ID in the ML probe request to be transmitted to the AP, e.g., as described below.

In some demonstrative aspects, the MLD ID may be configured to indicate that the non-collocated AP MLD is targeted by the ML probe request, e.g., as described below.

In some demonstrative aspects, controller 154 may be configured to control, trigger, cause, and/or instruct the non-AP STA implemented by device 140 to process an ML probe response from the AP, e.g., as described below.

In some demonstrative aspects, the ML probe response from the AP may include information of one or more APs affiliated with the non-collocated AP MLD, e.g., as described below.

In some demonstrative aspects, controller 154 may be configured to control, trigger, cause, and/or instruct the non-AP STA implemented by device 140 to set a link ID field in the ML probe request to identify a reported AP to be reported in the ML probe response, e.g., as described below.

In some demonstrative aspects, controller 154 may be configured to control, trigger, cause, and/or instruct the non-AP STA implemented by device 140 to determine whether or not the ML probe response includes information of all APs affiliated with the non-collocated AP MLD, for example, based on a field in the ML probe response, e.g., as described below.

In some demonstrative aspects, device 102, device 140, and/or device 150 may be configured to implement a non-collocated MLD operation mechanism to coordinate discovery/advertisement of non-collocated AP MLDs, e.g., as described below.

In some demonstrative aspects, the non-collocated MLD operation mechanism may define one or more discovery aspects to support discovery of an AP in a non-collocated AP MLD, e.g., as described below.

In some demonstrative aspects, it may be defined that an AP, e.g., each AP, in an ESS, may be affiliated with two AP MLDs, for example, a collocated AP MLD, and a non-collocated AP MLD.

In some demonstrative aspects, the non-collocated AP MLD may be defined as a multi-AP MLD, which may be defined to include a set of AP MLDs. For example, the AP MLDs may be affiliated with a non-collocated multi-AP MLD, and the APs affiliated with the AP MLDs may be defined, e.g., naturally defined, as a part of the non-collocated multi-AP MLD.

In some demonstrative aspects, it may be defined that an AP, e.g., each AP, may advertise the collocated AP MLD with which the AP is affiliated, and the non-collocated AP MLD with which the AP is affiliated, for example, in beacon/probe response frames transmitted by the AP. For example, the advertised collocated AP MLD may include a different AP MLD in different locations, and/or the non-collocated AP MLD may include a same AP MLD for all APs in the ESS.

In some demonstrative aspects, the non-collocated MLD operation mechanism may define one or more advertisement rules, e.g., as described below.

In some demonstrative aspects, the one or more advertisement rules may be configured to modify, add, and/or replace one or more advertisement rules defined for collocated AP MLD operation, e.g., as described below.

For example, an advertisement rule for collocated AP MLDs, e.g., in accordance with the 802.11be Specification, may define that all APs affiliated with the same AP MLD are advertised in an RNR in a beacon/probe response of each affiliated AP. According to this definition, the beacon/probe response of each affiliated AP may include an MLE to describe the AP MLD. For example, the MLE may include a MLD MAC address of the AP MLD, and/or any other additional or alternative information to describe the AP MLD.

In some demonstrative aspects, in case of a non-collocated AP MLD, the non-collocated AP MLD may include a relatively large, e.g., a huge, number of APs.

Accordingly, in some aspects, the advertisement rule may be relaxed for advertisement of a non-collocated AP MLD, e.g., as described below.

In some demonstrative aspects, the non-collocated MLD operation mechanism may define an advertisement rule, which may define that all APs affiliated with the same AP MLD and are part of a same collocated AP set as a reporting AP (e.g., an AP sending the frame), may, e.g., shall, be advertised in an RNR element in the beacon and/or probe response frames sent by the reporting AP.

In some demonstrative aspects,, other APs affiliated with the non-collocated AP MLD may optionally and/or selectively be included in the beacon and/or probe response frames of the reporting AP, e.g., not mandatorily.

In some demonstrative aspects, the advertisement rule may define that the AP, which is affiliated with the collocated AP MLD, may be affiliated with the non-collocated AP MLD.

In some demonstrative aspects, it may be defined that it is preferable for the AP, which is affiliated with the collocated AP MLD, to include only one TBTT information field, for example, instead of two information fields. For example, the TBTT information field may include one or more different MLD parameters fields.

In one example, the TBTT information field may be configured to include an MLD parameters field for the collocated AP MLD and an MLD parameters field for the non-collocated AP MLD. For example, the MLD parameters field for the collocated AP MLD may include an MLD ID for the collocated AP MLD, a link ID, and/or any other additional information for the collocated AP MLD. For example, the MLD parameters field for the non-collocated AP MLD may include an MLD ID for the non-collocated AP MLD, e.g., different from the MLD ID for the collocated AP MLD, a link ID, and/or any other additional information for the non-collocated AP MLD.

In some demonstrative aspects, an advertisement rule may define that the MLD parameters field is to include a non-collocated AP MLD flag field. For example, the non-collocated AP MLD flag field may be utilized, for example, in conjunction with an MLD ID, for example, to identify the non-collocated AP MLD or the collocated AP MLD. According to this example, both the non-collocated AP MLD and the collocated AP MLD may, e.g., will, have the same MLD ID.

In one example, the TBTT information field may be configured to include an MLD parameters field for the collocated AP MLD. For example, the MLD parameters field may include a non-collocated AP MLD flag indicating that the AP is part of the non-collocated AP MLD. For example, same MLD ID and/or link ID may be used for the non-collocated AP MLD and the collocated AP MLD. For example, a STA may include in an association request an MLD ID and a non-collocated AP MLD flag, for example, to differentiate between the collocated AP MLD and the non-collocated AP MLD.

In some demonstrative aspects, the advertisement rule may define that reserved bits in the MLD parameters field are to include a non-collocated MLD ID gap. For example, the MLD ID gap may correspond to the difference between the MLD ID of the non-collocated AP MLD and the MLD ID of the collocated AP MLD. For example, a non-zero value may be set to the non-collocated MLD ID gap, for example, to indicate that the AP is affiliated to both a collocated AP MLD and a non-collocated AP MLD. For example, the non-zero value of the non-collocated MLD ID gap may indicate, for example, that the MLD ID of the collocated AP MLD is the one indicated in the MLD ID field, and that the MLD ID of the non-collocated AP MLD is the sum of the MLD ID field and the non-collocated MLD ID gap.

In one example, the TBTT information field may be configured to include an MLD parameters field including the MLD ID for the collocated AP MLD. For example, the MLD parameters field may include a non-collocated AP MLD flag indicating that the AP is part of the non-collocated AP MLD, and a non-collocated MLD ID gap set to indicate the non-collocated MLD ID relative to the MLD ID for the collocated AP MLD.

In some demonstrative aspects, the collocated APs that are part of the collocated AP MLD may be advertised in the RNR element, e.g., in accordance with one or more advertisement rules defined in the 802.11be Specification.

In some demonstrative aspects, an advertisement rule may require not to advertise any other information related to the non-collocated AP MLD in the RNR element and have all information related to the non-collocated AP MLD to be included in an ML element, e.g., as described below. For example, APs that are collocated and part of the collocated AP MLD may be advertised, e.g., per advertisement rules defined in the 802.11be Specification.

In some demonstrative aspects, device 102, device 140, and/or device 150 may be configured to implement an ML element advertisement mechanism, e.g., as described below.

In some demonstrative aspects, the ML element advertisement mechanism may define an ML element configuration to support the non-collocated MLD operation, e.g., as described below.

In some demonstrative aspects, it may be defined that an ML element for the non-collocated AP MLD is to be included in a beacon and/or a probe response frame, e.g., in every beacon and every probe response frame, transmitted by an AP affiliated with the AP MLD, for example, in addition to an ML element for the collocated AP MLD.

In some demonstrative aspects, it may be defined that the ML element is to include an explicit indication (non-collocated AP MLD indication) that the AP MLD is a non-collocated AP MLD and that all AP MLDs are not advertised.

In some demonstrative aspects, the explicit non-collocated AP MLD indication may be included in the ML element describing the AP MLD.

In some demonstrative aspects, the explicit non-collocated AP MLD indication may be included in an RNR.

In other aspects, the explicit indication may be included in any other additional or alternative type of element and/or field.

In some demonstrative aspects, the explicit non-collocated AP MLD indication may be configured to indicate that all APs are advertised, e.g., in case all APs are being advertised by the ML element.

In some demonstrative aspects, the explicit non-collocated AP MLD indication may include one or more fields.

In some demonstrative aspects, it may be defined that an ML element describing the non-collocated AP MLD is not to be included in a beacon and/or probe response frame transmitted by an AP affiliated with a non-collocated AP MLD.

In some demonstrative aspects, it may be defined that the ML element describing the collocated AP MLD is to include an explicit indication, which is configured to indicate that there exists also a non-collocated AP MLD that encompasses the collocated AP MLD and that is not advertised here. For example, this definition may be used, for example, based on a condition that all APs affiliated with the collocated AP MLD are also affiliated with the non-collocated AP MLD.

In some demonstrative aspects, it may be defined that the ML element may, e.g., would, include a non-collocated AP MLD MAC address and/or an MLD ID of the non-collocated AP MLD, for example, if the MLD ID of the non-collocated AP MLD is different from an MLD ID of the collocated AP MLD.

For example, a new subfield, e.g., a “non-collocated MLD information” field, may be added, for example, in the common information field of the ML element. For example, the non-collocated MLD information field may be defined to contain one or more of the non-collocated AP MLD MAC address field, the MLD ID field, and/or any other additional or alternative information field corresponding to the non-collocated AP MLD.

In some demonstrative aspects, a STA of a non-AP MLD may receive from an AP a frame including the non-collocated MLD information field. For example, based on information in the non-collocated MLD information field, the STA of the non-AP MLD may be, e.g., will be, able to send a ML probe request frame to the AP asking for complete information for the non-collocated AP MLD.

In some demonstrative aspects, the non-collocated MLD operation mechanism may define communication of a ML probe request and/or a ML probe response, which may be configured to support the non-collocated MLD operation, e.g., as described below.

In some demonstrative aspects, a STA of a non-AP MLD may send a ML probe request frame to an AP of a non-collocated AP MLD, for example, by targeting the non-collocated AP MLD with one or more fields, for example, address fields, and/or with an MLD ID of the non-collocated AP MLD, e.g., as described below.

For example, a Receiver Address (RA) field and/or a Destination Address (DA) field in the ML probe request frame may be set to a Basic Service Set Identifier (BSSID) of the AP.

For example, the probe request frame may include the MLD ID of the non-collocated AP MLD. For example, the STA of the non-AP MLD may derive the MLD ID of the non-collocated AP MLD, for example, from the information found in an RNR or in an ML element in the beacon and/or probe response frame from the AP of the non-collocated AP MLD.

In some demonstrative aspects, it may be defined that if both the collocated AP MLD and the non-collocated AP MLD have the same MLD ID, a non-collocated AP MLD flag is to be added by the STA of the non-AP MLD to the ML probe request frame, for example, in addition to the MLD ID. For example, the non-collocated AP MLD flag may allow the AP of the non-collocated AP MLD to identify whether the ML probe request frame is for the non-collocated AP MLD or for the collocated AP MLD.

In some demonstrative aspects, the STA of the non-AP MLD may ask, e.g., in the ML probe request frame or in any other type of frame, for all APs to be reported. In some demonstrative aspects, it may be defined that the AP of the AP MLD may only send a complete profile for some of the APs, e.g., at least for the collocated APs, for example, when the STA of the non-AP MLD asks for all APs to be reported.

In some demonstrative aspects, it may be defined that an ML probe response from the AP of the non-collocated AP MLD may include, e.g., may need to have, a field indicating that all APs are not included in the ML probe response, or that all APs are included in the ML probe response.

In some demonstrative aspects, one or more enhancements may be defined to support communication of the ML probe request frame to ask the AP MLD to provide at least the non-collocated APs of the AP MLD that are the closest from the STA sending the ML probe request frame.

In some demonstrative aspects, it may be defined that, for example, unless the ML probe request frame is requesting all affiliated APs to be reported in the ML probe response frame, then the ML probe request frame has to identify which AP of the non-collocated AP MLD is to be reported.

In some demonstrative aspects, a Link ID field in per-STA profiles in the ML probe request frame of an ML element may be used, for example, in order for the STA of the non-AP MLD to identify the links.

In some demonstrative aspects, a link ID, which is advertised in beacons/probe frames, may relate to the collocated AP MLD. Accordingly, the ML probe request may be configured to identify the link, for example, by identifying the collocated AP MLD and the link ID of the collocated AP MLD. For example, the MLD MAC address of the collocated AP MLD and the Link ID field may be utilized to identify the link.

For example, the STA of the non-AP MLD may use the Link ID field in the per-STA profile of the ML probe request frame of the ML element. For example, the STA of the non-AP MLD may set the Link ID field to the link ID corresponding to the corresponding collocated AP MLD, and include in a same per-STA profile the MLD ID of the collocated AP MLD, or the MLD MAC address of the collocated AP MLD.

In some demonstrative aspects,, different link IDs of the non-collocated AP MLD may be advertised in the beacon and/or the ML probe response frame, for example, in addition to the link IDs for the collocated AP MLDs. For example, the STA of the non-AP MLD may use only the link ID field to identify the APs, with the link ID field set to the link ID of the non-collocated AP MLD and not to the link ID of the collocated AP MLD, for example, as the link IDs of the non-collocated AP MLD and the collocated AP MLD may be different. For example, the link ID of the non-collocated AP MLD may be defined per non-AP MLD, and not per AP MLD.

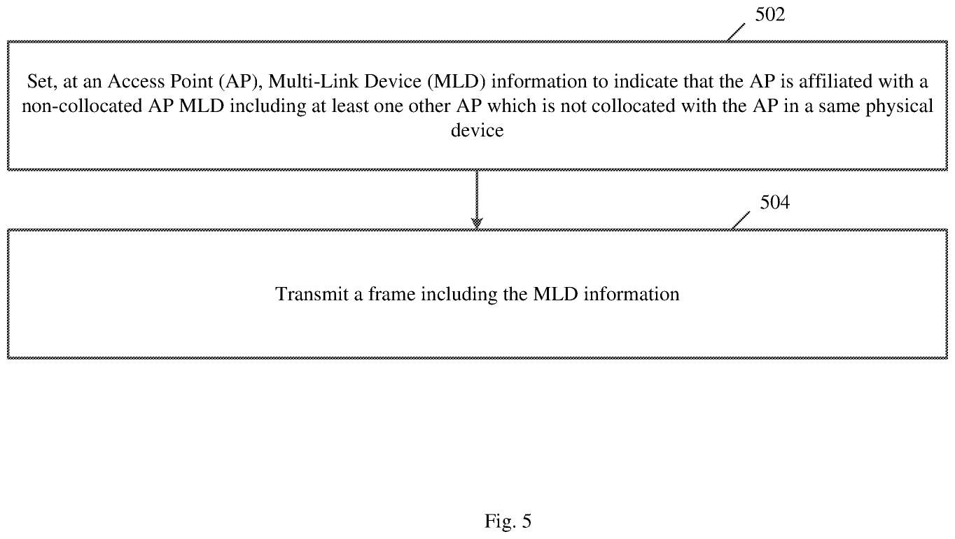

Reference is made to FIG. 5, which schematically illustrates a method of non-collocated MLD indication, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), and/or device 140 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include setting, at an AP, MLD information configured to indicate that the AP is affiliated with a non-collocated AP MLD. For example, the non-collocated AP MLD may include at least one other AP which is not collocated with the AP in a same physical device. For example, controller 124 (FIG. 1) may be configured to cause, trigger, and/or control device 102 (FIG. 1) to set MLD information to indicate that an AP implemented by device 102 (FIG. 1) is affiliated with a non-collocated AP MLD, e.g., as described above.

As indicated at block 504, the method may include transmitting a frame including the MLD information. For example, controller 124 (FIG. 1) may be configured to cause, trigger, and/or control device 102 (FIG. 1) to transmit a frame including the MLD information, e.g., as described above.

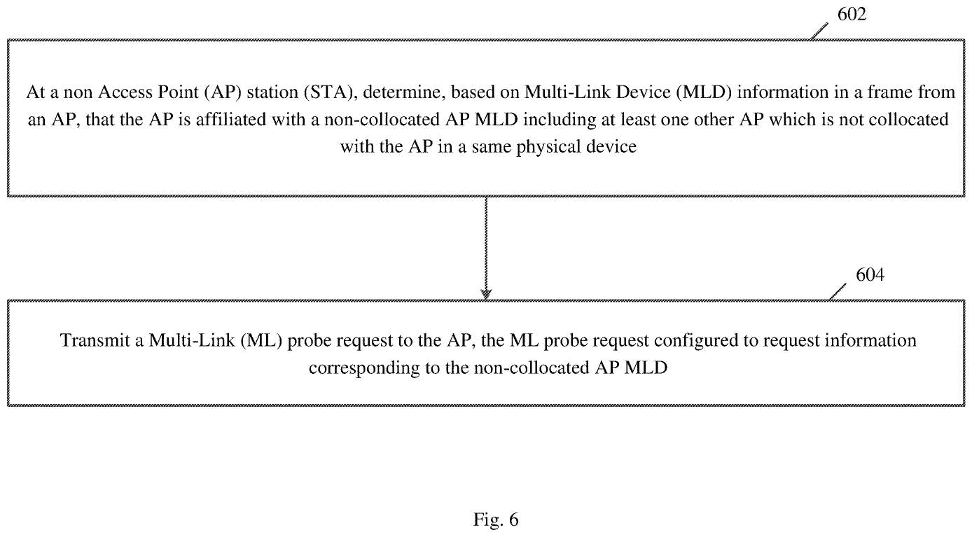

Reference is made to FIG. 6, which schematically illustrates a method of non-collocated MLD indication, in accordance with some demonstrative aspects. For example, one or more of the operations of the method of FIG. 6 may be performed by one or more elements of a system, e.g., system 100 (FIG. 1), for example, one or more wireless devices, e.g., device 102 (FIG. 1), and/or device 140 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 602, the method may include determining at a non-AP STA, e.g., based on MLD information in a frame from an AP, that the AP is affiliated with a non-collocated AP MLD. For example, the non-collocated AP MLD may include at least one other AP which is not collocated with the AP in a same physical device. For example, controller 154 (FIG. 1) may be configured to cause, trigger, and/or control device 140 (FIG. 1) to determine, based on MLD information in a frame from an AP, that the AP is affiliated with a non-collocated AP MLD, e.g., as described above.

As indicated at block 604, the method may include transmitting to the AP an ML probe request configured to request information corresponding to the non-collocated AP MLD. For example, controller 154 (FIG. 1) may be configured to cause, trigger, and/or control device 140 (FIG. 1) to transmit to the AP an ML probe request to request information corresponding to the non-collocated AP MLD affiliated with the AP, e.g., as described above.

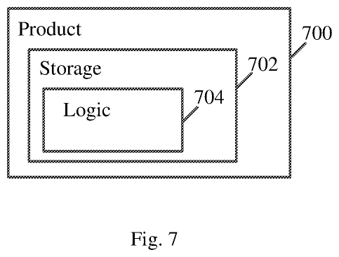

Reference is made to FIG. 7, which schematically illustrates a product of manufacture 700, in accordance with some demonstrative aspects. Product 700 may include one or more tangible computer-readable (“machine-readable”) non-transitory storage media 702, which may include computer-executable instructions, e.g., implemented by logic 704, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities, and/or to perform, trigger and/or implement one or more operations and/or functionalities described with reference to the FIGS. 1, 2, 3, 4, 5, and/or 6, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 700 and/or machine-readable storage media 702 may include one or more types of computer-readable storage media capable of storing data, including volatile memory, non-volatile memory, removable or non-removable memory, erasable or non-erasable memory, writeable or re-writeable memory, and the like. For example, machine-readable storage media 702 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 704 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 704 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause an Access Point (AP) to set Multi-Link Device (MLD) information to indicate that the AP is affiliated with a non-collocated AP MLD comprising at least one other AP which is not collocated with the AP in a same physical device; and transmit a frame comprising the MLD information.

Example 2 includes the subject matter of Example 1, and optionally, wherein the apparatus is configured to cause the AP to set a non-collocated AP MLD indication in an MLD parameters field of the frame to indicate that the AP is affiliated with the non-collocated AP MLD.

Example 3 includes the subject matter of Example 1 or 2, and optionally, wherein the apparatus is configured to cause the AP to set an MLD Identifier (ID) in an MLD parameters field of the frame, and to set a non-collocated AP MLD flag in the MLD parameters field to indicate that the non-collocated AP MLD is to be identified based on a combination of the MLD ID and the non-collocated AP MLD flag.

Example 4 includes the subject matter of Example 3, and optionally, wherein the apparatus is configured to cause the AP to set in the MLD parameters field an MLD ID of a collocated AP MLD affiliated with the AP, and to set the non-collocated AP MLD flag to a predefined value to indicate that the non-collocated AP MLD is to be identified by the MLD ID of the collocated AP MLD.

Example 5 includes the subject matter of Example 3, and optionally, wherein the apparatus is configured to cause the AP to set in the MLD parameters field an MLD ID of a collocated AP MLD affiliated with the AP, and to set the non-collocated AP MLD flag to a flag value to indicate that the non-collocated AP MLD is to be identified by a non-collocated AP MLD ID, wherein the non-collocated AP MLD ID is based on a sum of the MLD ID of the collocated AP MLD and a gap value, wherein the gap value is based on the flag value.

Example 6 includes the subject matter of Example 1, and optionally, wherein the apparatus is configured to cause the AP to set a first MLD parameters field and a second MLD parameter field in the frame, the first MLD parameters field comprising a first MLD Identifier (ID) to identify a collocated AP MLD affiliated with the AP, the second MLD parameters field comprising a second MLD ID to identify the non-collocated AP MLD.

Example 7 includes the subject matter of any one of Examples 1-6, and optionally, wherein the apparatus is configured to cause the AP to set a non-collocated AP MLD indication in a Multi-Link Element (MLE) of the frame to indicate that the AP is affiliated with the non-collocated AP MLD.

Example 8 includes the subject matter of Example 7, and optionally, wherein the apparatus is configured to cause the AP to set in the MLE at least one of an MLD Identifier (ID) of the non-collocated AP MLD, or an AP MLD Medium Access Control (MAC) address of the non-collocated AP MLD.

Example 9 includes the subject matter of Example 8, and optionally, wherein the apparatus is configured to cause the AP to set a non-collocated AP MLD information field in a common information field of the MLE, wherein the non-collocated AP MLD information field comprises at least one of an MLD Identifier (ID) of the non-collocated AP MLD, or an AP MLD Medium Access Control (MAC) address of the non-collocated AP MLD.

Example 10 includes the subject matter of Example 8 or 9, and optionally, wherein the MLE comprises information of a collocated AP MLD affiliated with the AP.

Example 11 includes the subject matter of any one of Examples 1-10, and optionally, wherein the apparatus is configured to cause the AP to set a first MLE and a second MLE in the frame, wherein the first MLE comprises information of a collocated AP MLD affiliated with the AP, wherein the second MLE comprises information of the non-collocated AP MLD.

Example 12 includes the subject matter of any one of Examples 1-11, and optionally, wherein the apparatus is configured to cause the AP to set a Reduced Neighbor Report (RNR) element in the frame to advertise all APs, which are affiliated with a same AP MLD and which are part of a same collocated AP set as the AP.

Example 13 includes the subject matter of any one of Examples 1-12, and optionally, wherein the apparatus is configured to cause the AP to process a Multi-Link (ML) probe request from a non-AP STA, and to identify that the non-collocated AP MLD is targeted by the ML probe request based on an MLD Identifier (ID) in the ML probe request.

Example 14 includes the subject matter of Example 13, and optionally, wherein the apparatus is configured to cause the AP to transmit an ML probe response to the non-AP STA, the ML probe response comprising information of one or more APs affiliated with the non-collocated AP MLD.

Example 15 includes the subject matter of Example 14, and optionally, wherein the apparatus is configured to cause the AP to identify a reported AP to be reported in the ML probe response based on a link identifier (ID) field in the ML probe request, and to include in the ML probe response information corresponding to the reported AP.

Example 16 includes the subject matter of Example 14 or 15, and optionally, wherein the apparatus is configured to cause the AP to set a field in the ML probe response to indicate whether or not the ML probe response comprises information of all APs affiliated with the non-collocated AP MLD.

Example 17 includes the subject matter of any one of Examples 1-16, and optionally, wherein the apparatus is configured to cause the AP to set the MLD information in an MLD parameters field of the frame.

Example 18 includes the subject matter of Example 17, and optionally, wherein the frame comprises a Reduced Neighbor Report (RNR) element, the RNR element comprising a neighbor AP information field comprising a Target Beacon Transmission Time (TBTT) information field, wherein the TBTT information field comprises the MLD parameters field.

Example 19 includes the subject matter of any one of Examples 1-18, and optionally, wherein the MLD information is configured to indicate that the AP is affiliated with both the non-collocated AP MLD and a collocated AP MLD.

Example 20 includes the subject matter of any one of Examples 1-19, and optionally, wherein the non-collocated AP MLD comprises one or more collocated AP MLDs, wherein a collocated AP MLD comprises a collocated AP set comprising a plurality of collocated APs.

Example 21 includes the subject matter of any one of Examples 1-20, and optionally, wherein the non-collocated AP MLD has one Medium Access Control (MAC) data service and a single MAC Service Access Point (SAP) to a Logical Link Control (LLC) layer.

Example 22 includes the subject matter of any one of Examples 1-21, and optionally, wherein the frame comprises a beacon frame or a probe response frame.

Example 23 includes the subject matter of any one of Examples 1-22, and optionally, comprising a radio to transmit the frame.

Example 24 includes the subject matter of Example 23, and optionally, comprising one or more antennas connected to the radio, and a processor to execute instructions of an operating system of the AP.

Example 25 includes an apparatus comprising logic and circuitry configured to cause a non Access Point (AP) station (STA) to determine, based on Multi-Link Device (MLD) information in a frame from an AP, that the AP is affiliated with a non-collocated AP MLD comprising at least one other AP which is not collocated with the AP in a same physical device; and transmit a Multi-Link (ML) probe request to the AP, the ML probe request configured to request information corresponding to the non-collocated AP MLD.

Example 26 includes the subject matter of Example 25, and optionally, wherein the apparatus is configured to cause the non-AP STA to determine that the AP is affiliated with the non-collocated AP MLD based on a non-collocated AP MLD indication in an MLD parameters field of the frame.

Example 27 includes the subject matter of Example 25 or 26, and optionally, wherein the apparatus is configured to cause the non-AP STA to process an MLD parameters field of the frame to determine that the non-collocated AP MLD is to be identified based on a combination of an MLD Identifier (ID) and a non-collocated AP MLD flag in the MLD parameters field.

Example 28 includes the subject matter of Example 27, and optionally, wherein the apparatus is configured to cause the non-AP STA to identify that the MLD parameters field comprises an MLD ID of a collocated AP MLD affiliated with the AP, and to determine, based on a determination that the non-collocated AP MLD flag has a predefined value, that the non-collocated AP MLD is to be identified by the MLD ID of the collocated AP MLD.

Example 29 includes the subject matter of Example 27, and optionally, wherein the apparatus is configured to cause the non-AP STA to identify that the MLD parameters field comprises an MLD ID of a collocated AP MLD affiliated with the AP, and to determine that the non-collocated AP MLD is to be identified by a non-collocated AP MLD ID, wherein the non-collocated AP MLD ID is based on a sum of the MLD ID of the collocated AP MLD and a gap value, wherein the gap value is based on a flag value of the non-collocated AP MLD flag.

Example 30 includes the subject matter of Example 25, and optionally, wherein the apparatus is configured to cause the non-AP STA to process a first MLD parameters field and a second MLD parameter field in the frame, the first MLD parameters field comprising a first MLD Identifier (ID) to identify a collocated AP MLD affiliated with the AP, the second MLD parameters field comprising a second MLD ID to identify the non-collocated AP MLD.

Example 31 includes the subject matter of any one of Examples 25-30, and optionally, wherein the apparatus is configured to cause the non-AP STA to determine that the AP is affiliated with the non-collocated AP MLD based on a non-collocated AP MLD indication in a Multi-Link Element (MLE) of the frame.

Example 32 includes the subject matter of Example 31, and optionally, wherein the apparatus is configured to cause the non-AP STA to process the MLE to identify at least one of an MLD Identifier (ID) of the non-collocated AP MLD, or an AP MLD Medium Access Control (MAC) address of the non-collocated AP MLD.

Example 33 includes the subject matter of Example 32, and optionally, wherein the apparatus is configured to cause the non-AP STA to process a non-collocated AP MLD information field in a common information field of the MLE, wherein the non-collocated AP MLD information field comprises at least one of an MLD Identifier (ID) of the non-collocated AP MLD, or an AP MLD Medium Access Control (MAC) address of the non-collocated AP MLD.

Example 34 includes the subject matter of Example 32 or 33, and optionally, wherein the MLE comprises information of a collocated AP MLD affiliated with the AP.

Example 35 includes the subject matter of any one of Examples 25-34, and optionally, wherein the apparatus is configured to cause the non-AP STA to process a first MLE and a second MLE in the frame, wherein the first MLE comprises information of a collocated AP MLD affiliated with the AP, wherein the second MLE comprises information of the non-collocated AP MLD.

Example 36 includes the subject matter of any one of Examples 25-35, and optionally, wherein the apparatus is configured to cause the non-AP STA to process a Reduced Neighbor Report (RNR) element in the frame to identify all APs, which are affiliated with a same AP MLD and which are part of a same collocated AP set as the AP.

Example 37 includes the subject matter of any one of Examples 25-36, and optionally, wherein the apparatus is configured to cause the non-AP STA to set an MLD Identifier (ID) in the ML probe request, the MLD ID configured to indicate that the non-collocated AP MLD is targeted by the ML probe request.

Example 38 includes the subject matter of Example 37, and optionally, wherein the apparatus is configured to cause the non-AP STA to process an ML probe response from the AP, the ML probe response comprising information of one or more APs affiliated with the non-collocated AP MLD.

Example 39 includes the subject matter of Example 38, and optionally, wherein the apparatus is configured to cause the non-AP STA to set a link identifier (ID) field in the ML probe request to identify a reported AP to be reported in the ML probe response.

Example 40 includes the subject matter of Example 38 or 39, and optionally, wherein the apparatus is configured to cause the non-AP STA to determine, based on a field in the ML probe response, whether or not the ML probe response comprises information of all APs affiliated with the non-collocated AP MLD.

Example 41 includes the subject matter of any one of Examples 24-40, and optionally, wherein the apparatus is configured to cause the non-AP STA to identify the MLD information in an MLD parameters field of the frame.

Example 42 includes the subject matter of Example 41, and optionally, wherein the frame comprises a Reduced Neighbor Report (RNR) element, the RNR element comprising a neighbor AP information field comprising a Target Beacon Transmission Time (TBTT) information field, wherein the TBTT information field comprises the MLD parameters field.

Example 43 includes the subject matter of any one of Examples 24-42, and optionally, wherein the apparatus is configured to cause the non-AP STA to identify, based on the MLD information, that the AP is affiliated with both the non-collocated AP MLD and a collocated AP MLD.

Example 44 includes the subject matter of any one of Examples 24-43, and optionally, wherein the non-collocated AP MLD comprises one or more collocated AP MLDs, wherein a collocated AP MLD comprises a collocated AP set comprising a plurality of collocated APs.

Example 45 includes the subject matter of any one of Examples 24-44, and optionally, wherein the non-collocated AP MLD has one Medium Access Control (MAC) data service and a single MAC Service Access Point (SAP) to a Logical Link Control (LLC) layer.

Example 46 includes the subject matter of any one of Examples 24-45, and optionally, wherein the frame comprises a beacon frame or a probe response frame.

Example 47 includes the subject matter of any one of Examples 24-46, and optionally, comprising a radio to receive the frame and transmit the ML probe request.

Example 48 includes the subject matter of Example 47, and optionally, comprising one or more antennas connected to the radio, and a processor to execute instructions of an operating system of the non-AP STA.

Example 49 comprises a wireless communication device comprising the apparatus of any of Examples 1-48.

Example 50 comprises an apparatus comprising means for executing any of the described operations of any of Examples 1-48.

Example 51 comprises a product comprising one or more tangible computer-readable non-transitory storage media comprising instructions operable to, when executed by at least one processor, enable the at least one processor to cause a wireless communication device to perform any of the described operations of any of Examples 1-48.

Example 52 comprises an apparatus comprising: a memory interface; and processing circuitry configured to: perform any of the described operations of any of Examples 1-48.

Example 53 comprises a method comprising any of the described operations of any of Examples 1-48.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

1.-25. (canceled)

26. An apparatus comprising logic and circuitry configured to cause an Access Point (AP) to:
set Multi-Link Device (MLD) information to indicate that the AP is affiliated with a non-collocated AP MLD comprising at least one other AP which is not collocated with the AP in a same physical device; and
transmit a frame comprising the MLD information.

27. The apparatus of claim 26 configured to cause the AP to set a non-collocated AP MLD indication in an MLD parameters field of the frame to indicate that the AP is affiliated with the non-collocated AP MLD.

28. The apparatus of claim 26 configured to cause the AP to set an MLD Identifier (ID) in an MLD parameters field of the frame, and to set a non-collocated AP MLD flag in the MLD parameters field to indicate that the non-collocated AP MLD is to be identified based on a combination of the MLD ID and the non-collocated AP MLD flag.

29. The apparatus of claim 28 configured to cause the AP to set in the MLD parameters field an MLD ID of a collocated AP MLD affiliated with the AP, and to set the non-collocated AP MLD flag to a predefined value to indicate that the non-collocated AP MLD is to be identified by the MLD ID of the collocated AP MLD.

30. The apparatus of claim 28 configured to cause the AP to set in the MLD parameters field an MLD ID of a collocated AP MLD affiliated with the AP, and to set the non-collocated AP MLD flag to a flag value to indicate that the non-collocated AP MLD is to be identified by a non-collocated AP MLD ID, wherein the non-collocated AP MLD ID is based on a sum of the MLD ID of the collocated AP MLD and a gap value, wherein the gap value is based on the flag value.

31. The apparatus of claim 26 configured to cause the AP to set a first MLD parameters field and a second MLD parameter field in the frame, the first MLD parameters field comprising a first MLD Identifier (ID) to identify a collocated AP MLD affiliated with the AP, the second MLD parameters field comprising a second MLD ID to identify the non-collocated AP MLD.

32. The apparatus of claim 26 configured to cause the AP to set a non-collocated AP MLD indication in a Multi-Link Element (MLE) of the frame to indicate that the AP is affiliated with the non-collocated AP MLD.

33. The apparatus of claim 32 configured to cause the AP to set in the MLE at least one of an MLD Identifier (ID) of the non-collocated AP MLD, or an AP MLD Medium Access Control (MAC) address of the non-collocated AP MLD.

34. The apparatus of claim 33 configured to cause the AP to set a non-collocated AP MLD information field in a common information field of the MLE, wherein the non-collocated AP MLD information field comprises at least one of an MLD Identifier (ID) of the non-collocated AP MLD, or an AP MLD Medium Access Control (MAC) address of the non-collocated AP MLD.

35. The apparatus of claim 26 configured to cause the AP to set a first MLE and a second MLE in the frame, wherein the first MLE comprises information of a collocated AP MLD affiliated with the AP, wherein the second MLE comprises information of the non-collocated AP MLD.

36. The apparatus of claim 26 configured to cause the AP to set a Reduced Neighbor Report (RNR) element in the frame to advertise all APs, which are affiliated with a same AP MLD and which are part of a same collocated AP set as the AP.

37. The apparatus of claim 26 configured to cause the AP to process a Multi-Link (ML) probe request from a non-AP STA, and to identify that the non-collocated AP MLD is targeted by the ML probe request based on an MLD Identifier (ID) in the ML probe request.

38. The apparatus of claim 37 configured to cause the AP to transmit an ML probe response to the non-AP STA, the ML probe response comprising information of one or more APs affiliated with the non-collocated AP MLD.

39. The apparatus of claim 38 configured to cause the AP to identify a reported AP to be reported in the ML probe response based on a link identifier (ID) field in the ML probe request, and to include in the ML probe response information corresponding to the reported AP.

40. The apparatus of claim 26 configured to cause the AP to set the MLD information in an MLD parameters field of the frame.

41. The apparatus of claim 26, wherein the MLD information is configured to indicate that the AP is affiliated with both the non-collocated AP MLD and a collocated AP MLD.

42. The apparatus of claim 26, wherein the non-collocated AP MLD comprises one or more collocated AP MLDs, wherein a collocated AP MLD comprises a collocated AP set comprising a plurality of collocated APs.

43. The apparatus of claim 26 comprising a radio to transmit the frame, one or more antennas connected to the radio, and a processor to execute instructions of an operating system.

44. An apparatus comprising logic and circuitry configured to cause a non Access Point (AP) station (STA) to:
determine, based on Multi-Link Device (MLD) information in a frame from an AP, that the AP is affiliated with a non-collocated AP MLD comprising at least one other AP which is not collocated with the AP in a same physical device; and
transmit a Multi-Link (ML) probe request to the AP, the ML probe request configured to request information corresponding to the non-collocated AP MLD.

45. The apparatus of claim configured to cause the non-AP STA to determine that the AP is affiliated with the non-collocated AP MLD based on a non-collocated AP MLD indication in an MLD parameters field of the frame.
